(19) United States
(12) Patent Application Publication
(10) Pub. No.: US 2002/0106044 A1
(43) Pub. Date: Aug. 8, 2002

(54) Method for generating a serial bitstream comprising information for synchronization

(76) Inventors: Sebastian Egner, Eindhoven (NL); Constant Paul Marie Jozef Baggen, Eindhoven (NL); Marten Erik Van Dijk, Eindhoven (NL)

Correspondence Address: Corporate Patent Counsel, U.S. Philips Corporation, 580 White Plains Road, Tarrytown, NY, 10591, US

(21) Appl. No.: 09/995,998

(22) Filed: Nov. 16, 2001

(30) Foreign Application Priority Data
Nov. 21, 2000 (EP) 00204133.3

(51) Int. Cl. H04L 7/00

(52) U.S. Cl. 375/365

(57) ABSTRACT

The invention relates to a method for generating a serial bitstream comprising information for synchronizing the serial bitstream internally and/or to another serial bitstream and/or for determining the position in the serial bitstream wherein a fixed code pattern is embedded in the serial bitstream. In order to retrieve a synchronization information or to determine the position in the serial bitstream very fast after the start of reading the serial bitstream and at any time during reading the serial bitstream it is provided according to the invention that the code pattern is periodically repeated in the serial bitstream and that any sequence of a fixed number of successive bits of the code pattern forms a unique code word allowing for synchronization and/or position determination, even under the occurrence of bit errors. The invention also refers to a corresponding device, to a binary signal comprising a serial bitstream, to a record carrier carrying such a binary signal and to a method and device for reading such a binary signal.

The invention relates to a method for generating a serial bitstream comprising information for synchronizing the serial bitstream internally and/or to another serial bitstream and/or for determining the position in the serial bitstream wherein a fixed code pattern is embedded in the serial bitstream. The invention relates further to a device for generating such a serial bitstream, to a binary signal comprising a serial bitstream, to a record carrier carrying such a binary signal and to a method and device for reading such a binary signal.

A method and an apparatus for the fast detection of a predetermined pattern of n bits embedded in a serial bitstream is disclosed in U.S. Pat. No. 4,847,877. Therein the n bits are adjacent or regularly distributed over the bitstream and form a unique word which may be used as a synchronization pattern. Such stored unique word is searched in the serial bitstream. The detection of the unique word allows to conclude that a synchronization status has been reached.

With the known method it is, however, not possible to get into the synchronization status at other positions of the bitstream, i. e. before the unique word has been found in the serial bitstream. Further, a position detection within the bitstream is only possible after the unique word has been found. A mutual synchronization of two serial bitstreams of different channels, and also an internal synchronization of one serial bitstream is often required which should be possible at each position within the bitstream and after the start of reading the bitstream which start of reading can lie at each position within the bitstream. Further, the detection of the actual position within the serial bitstream should be possible from the code pattern embedded in the serial bitstream at any time. For some applications the detection should also be able to synchronize under random bit errors.

A method for determining the position of a carriage along a linear axis it is known from van Tilborg et al., “Code voor positionering van een as”, IWDE Report 94-02, Eindhoven, March 1994. Therein a code pattern is fixed to the linear axis. By reading a fixed part of this code pattern the position along the linear axis can be determined, even under the presence of bit errors. The code pattern is generated as linear feedback shift register sequence of a predetermined length.

It is therefore the object of the invention to provide a method and device for the purposes mentioned above which allow synchronization and/or position detection from the code pattern at any position in the bitstream reliably in the presence of bit errors.

This object is achieved by a method according to claim 1 and a corresponding device according to claim 8.

The invention is based on the idea that a position detection and synchronization is possible at any time during reading or decoding of the serial bitstream if the code pattern comprises code words consisting of a fixed number of successive bits of the code pattern. Additionally, this code pattern is periodically repeated in the serial bitstream. This means that a code pattern of n bits comprises n unique code words of a fixed length each allowing to uniquely determine the position in the bitstream. Each of the n code words starts at a different position in the code pattern but comprises the same fixed number of successive bits of the code pattern. At the beginning of reading the serial bitstream it is thus possible after the detection of this fixed number of bits of the code pattern to determine the position or to synchronize the bitstream for the first time. Thereafter synchronization and position detection is continuously possible since each following code word includes some—primarily the fixed number minus one—bits of the previous code word.

In contrast to the method known from van Tilburg et al. the invention allows to repeat the pattern periodically with a period that is not of the form 2^{m}−1.

In the preferred embodiment of claim 2 at least a one-bit error in any code word is correctable. This requires that the minimum distance of the code words is three, i. e. any two different code words differ in at least three bits. This additional redundancy can also be used to decrease the probability of misdetection, i. e. the output of a wrong position. Such bit errors can be introduced in the bitstream or the code word randomly. To provide such a possibility for correction of one-bit errors it is necessary that the number of successive bits forming the code words is higher compared to the number of successive bits for code words not having such a possibility for correction. If larger errors than 1-bit errors in the code words shall be correctable the minimum distance of the code words has to be increased which is possible according to the invention. Also the number of bits forming a code word then have to be increased.

Another preferred embodiment according to claim 3 allows reliable detection of a fixed reference position, namely a marker which is a code word having a minimum distance of at least three from any other code word of the code pattern. It is however possible that two other codewords are distinct but have lower distance to one another than the marker has with any other codeword. The length of the code words used in this embodiment can be smaller compared to the length of the code words used in the embodiment according to claim 2. But nevertheless a one-bit error in the marker can also be corrected in this embodiment. However, one-bit errors in other code words used in this embodiment are not necessarily correctable due to the shorter length and the smaller minimum distance among these code words.

In a further preferred embodiment the code words are generated and/or detected by a linear feedback shift register (LFSR). Such shift registers are very simple to implement thus reducing the costs for a decoder or a reading device for decoding and/or reading the bitstream into which the code pattern is embedded. Preferably such linear feedback shift registers can also be used to generate the code pattern. Alternatively the code words can also be detected using other means, and a translation from a code word into a position information can be done using a look-up table storing the information concerning the reference between the code words and the corresponding positions in the bitstream.

The code pattern according to the invention is preferably embedded in a channel bitstream of user data stored on a record carrier or transmitted over a transmission line. Such user data can be any kind of data, e. g. MPEG-2 multi-channel audio data or video data. The code pattern can for example be embedded in an EFM (eight-to-fourteen-modulation) channel storing audio data on a CD or in LML (limited multi-level) channel which is created on top of the physical EFM channel via a binary amplitude modulation of long run-lengths in the EFM bitstream. Such a channel bitstream can be used to store data on a magnetic tape or on an optical record carrier like a CD or a DVD. Such a channel bitstream can also be transmitted over a transmission line, like a telephone line for transmitting data from a server connected to the internet to a certain user downloading these data.

According to the preferred embodiment of claim 6 the serial bitstream is separated into superframes consisting of a fixed number of frames. The code pattern according to the invention is then completely embedded in one superframe. In each of the superframes forming the serial bitstream the same code pattern will then be embedded so that the code pattern is periodically repeated the period of the code pattern being the same as the period of the superframes. A synchronization of the superframes can thus be derived from the code pattern.

It is further preferred that in each frame of such superframes one bit of the code pattern is embedded as claimed in claim 7. It is thus achieved that not too much storage space being available in each frame needs to be reserved for the bits of the code pattern.

The object of the invention is also achieved by a device according to claim 8.

The invention further relates to a binary signal according to claim 9 comprising a serial bitstream in which the described code pattern is embedded. The invention still further relates to a record carrier according to claim 10 storing such a binary signal which record carrier preferably is a CD or a DVD. Still further the invention relates to a method and a device for reading such a binary signal as claimed in claims 12 and 14. It shall be understood that such embodiments of the invention can be developed further and can have further embodiments which are identical or similar to those embodiments which have been described above with reference to the method according to claim 1 and which are laid down in the subclaims of claim 1.

The invention shall now be explained in more detail with reference to the figures in which

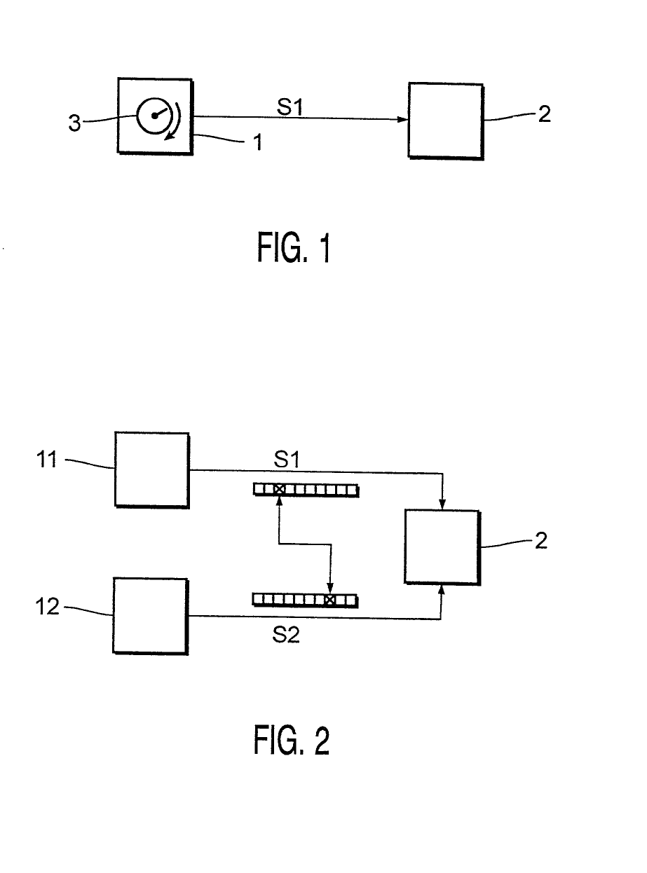

FIGS. 1 and 2 show simple block diagrams explaining the need for synchronization and position detection,

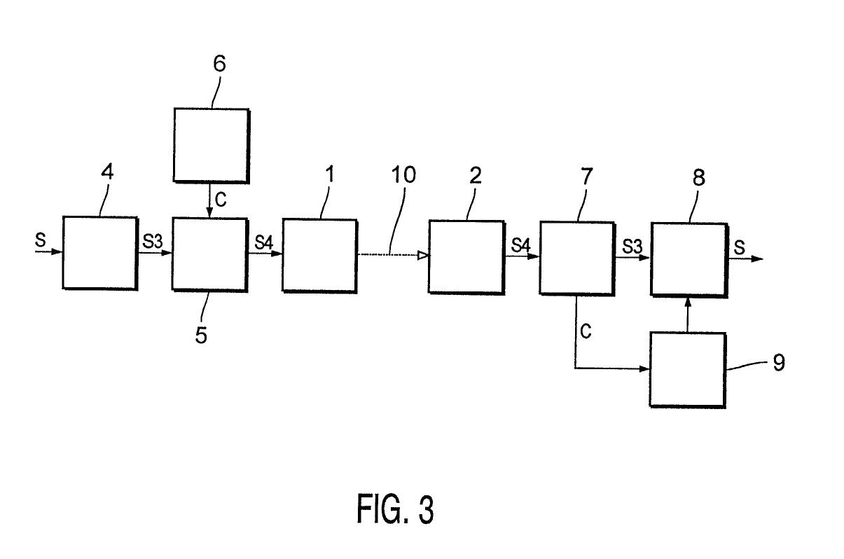

FIG. 3 shows a block diagram of a first embodiment of the invention,

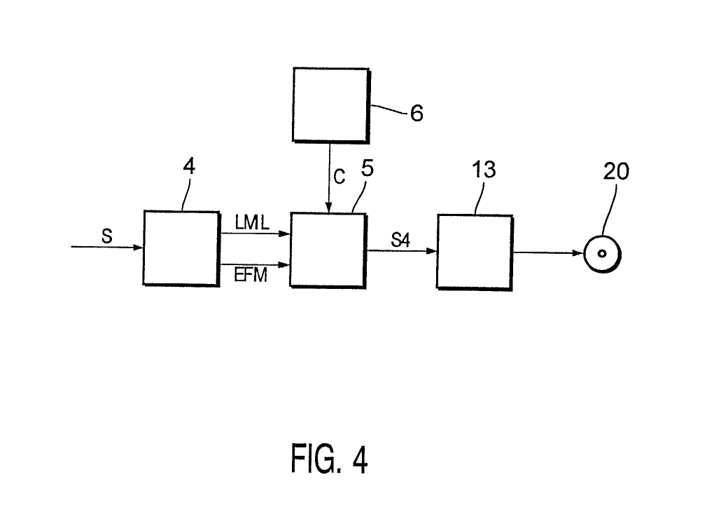

FIG. 4 shows a block diagram of another embodiment of the invention,

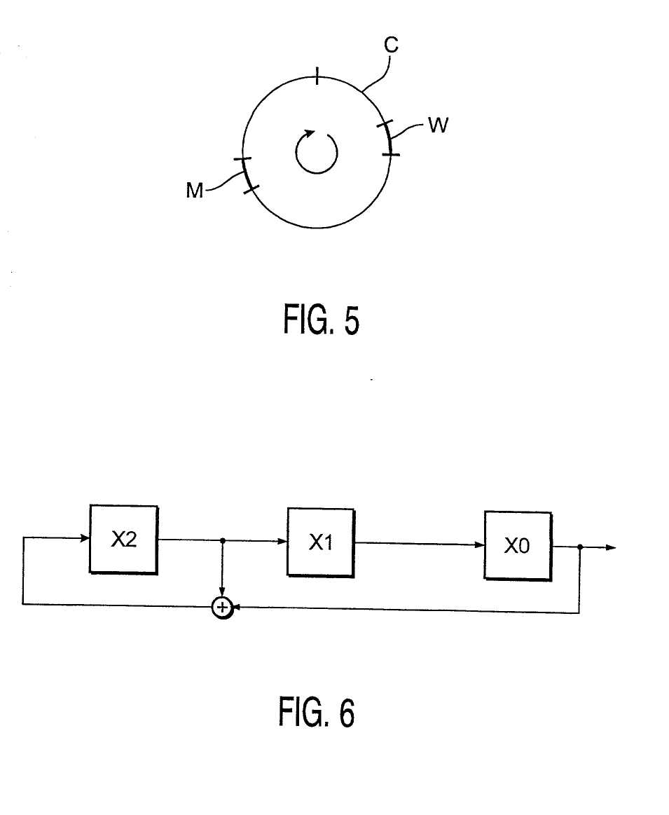

FIG. 5 shows the arrangement of a code pattern according to the invention,

FIG. 6 shows an embodiment of a LFSR for generating a code pattern according to the invention,

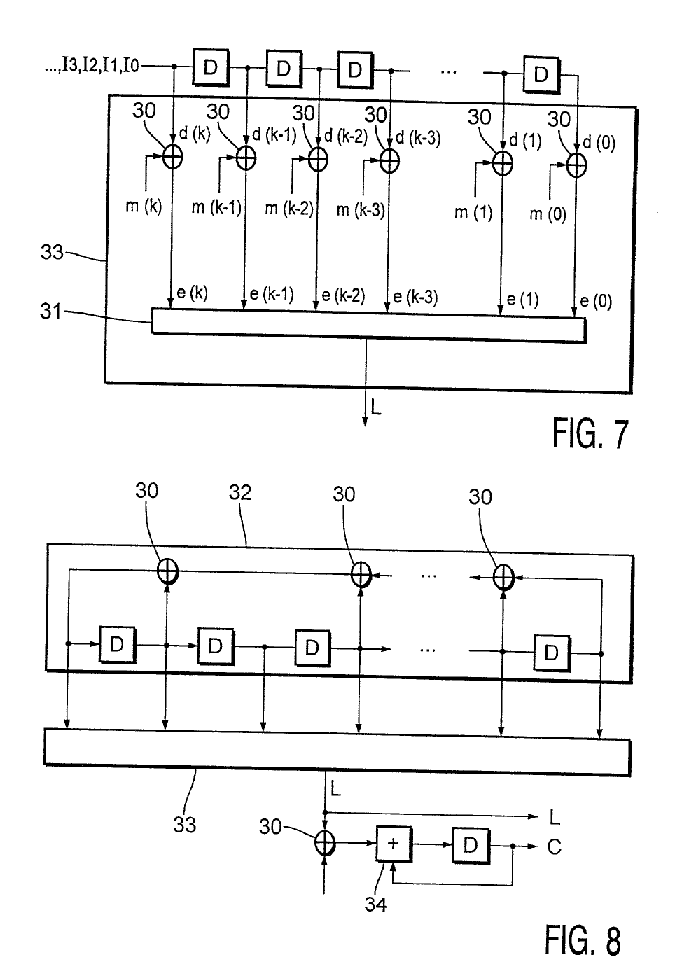

FIG. 7 shows another embodiment of a LFSR for locating a marker with error-correction according to the invention and

FIG. 8 shows an embodiment of a LFSR for decoding a position according to the invention.

FIG. 1 shows in a simple block diagram a transmitter 1 transmitting a serial bit-stream S1 to a receiver 2. The transmission of the bitstream S1 is clocked by a clock 3 in the transmitter 1. This situation appears in nearly every communication system without payload where the transmitter 1 usually transmits a synchronization bitstring periodically. At a random point in time the receiver 2 is switched on and starts receiving bits. The receiver 2 then wants to know the relative position within the transmitted bitstream S1 as soon as possible by looking at the received bits. The most simple solution would be to choose a synchronization bitstring with n-1 zeros and a single one. When the receiver 2 detects the one then it knows where the transmitter 1 is, i. e. the receiver then gets into lock. Obviously, if the one just passed before the receiver 2 is switched on then it has to wait for n-1 bits to find the one. In addition, random bit errors can spoil the detection and confuse the receiver 2.

FIG. 2 shows another block diagram where two transmitters 11, 12 separately transmit a serial bitstream S1, S2 to a receiver 2. Before the two bitstreams 1, S2 can be further processed it is usually necessary that the two bitstreams S1, S2 are mutually synchronized in the receiver 2, i. e. it has to be determined which bit of the first bitstream S1 belongs to which bit of the second bitstream S2. As an example an audio data stream S1 has to be synchronized to its corresponding video data stream S2 for a correct playback of a video.

FIG. 3 shows a block diagram of a first embodiment of the invention. Therein a stream of data S shall be transmitted over a transmission line 10 or shall be recorded on a record carrier (not shown) for storage and reproduction at a later point in time. The stream of data S is first processed by a data processing means 4 which can comprise a CIRC-encoder and an EFM-modulator in a CD-system. The resulting serial bitstream S3 is then further encoded by coding means 5 which embed a code pattern C according to the invention into the serial bitstream S3 thus generating a serial bitstream S4 which is outputted to the transmitter 1. The code pattern C is therein generated by code generating means 6 taking into account the format of the serial bitstream S3 and the required features of the code pattern C. After transmission over the transmission line 10 the bitstream S4 is received by a receiver 2 and outputted to decoding means 7. Therein the code pattern C is detected in the bitstream S4 and outputted to a code processing means 9 while the bitstream S3 containing the user data is outputted to a data processing means 8 where the original user data S can be reproduced. Therefore data provided from the code processing means 9 can be used which can be a synchronization information internally synchronizing the serial bitstream S3 or synchronizing the bitstream S3 to another bitstream which is not shown in FIG. 3. The code processing means 9 are developed for converting the code pattern C into a synchronization information or into an information about the current position in the serial bitstream S3.

Another embodiment of the invention is shown in the block diagram of FIG. 4. By the data processing means 4 two channel bitstreams of data are generated from the user data S, in particular a LML channel and an EFM channel where the LML channel is created on top of the physical EFM channel via a binary amplitude modulation of long run-lengths in the EFM bitstream. The code pattern C is then embedded in the LML channel by the coding means 5, and the serial bitstream S4 comprising the LML channel, the EFM channel and the code pattern is outputted to a recording means 13 recording these data on a record carrier 20, e.g. on a CD.

As an example for the storage of digital audio data on a CD a format based on superframes can be used, each superframe being compatible with 1152 stereo PCM samples grouped into 192 F3-frames having 24 user bytes per F3-frame. A buried-data channel (BDC) can be based on one such superframe, and the error correction code (ECC)-cluster for a CD can consist of two such superframes forming a double superframe. The LML channel and the BDC channel both need then internal synchronization and mutual synchronization. Originally a synchronization pattern for a BDC channel only was allocated to the beginning of each BDC superframe. However, this would also apply to areas of digital silence (like pauses in CD), where the signal-to-noise ratio is often measured and further used as a kind of quality criterion. In order to avoid any penalty in this respect it is proposed according to the invention to perform synchronization only in the LML channel keeping digital silences really silent, and to derive the synchronization for the BDC superframe therefrom.

It is thus proposed to create a synchronization via the LML effect in the first 11T run of each F3-frame which occur in the F3-synchronization of the CD-format at the beginning of each F3-frame. These bits are called synchronization bits, together forming the code pattern according to the invention. Since in the example a single double superframe contains 384 F3-frames there are 384 such bits in a double superframe. Therefore a fixed code pattern of 384 bits can be embedded in a double superframe.

Such a code pattern shall be explained with reference to FIG. 5. Therein it is shown that the code pattern C is arranged on a circle which means that the code pattern is repeated periodically. The code pattern used according to the invention is selected such that any window W of a certain fixed number of consecutive bits of the code pattern C forms a unique code word comprising information about the position within the code pattern and within the bitstream. In particular in a code pattern C consisting of n bits there are n unique windows W (code words) of consecutive bits each code word starting at a different position within the code pattern C.

In the example described above where a single double superframe contains 384 F3-frames the following fixed code pattern can be embedded in each double superframe:

| | | | |
|---|---|---|---|
| 1100001001111110 | 0000010010100001 | 0100110011100101 | 0010010011000101 |
| 1111101011111000 | 1010100000001110 | 0111110011101110 | 1000110001110001 |
| 0000110101011001 | 0101111001100000 | 0001011101010001 | 0110100111101111 |
| 0100001111101100 | 1101110011010111 | 0111111111001011 | 0011110010011101 |
| 0110101100000101 | 0110111011010001 | 0011010010101010 | 1110010001010001 |
| 1101001101100100 | 0000110010010110 | 1100001110110001 | 1001100101110000 |

The fundamental property of this code pattern is that any 9 consecutive bits determine the position within the code pattern uniquely, even if the code pattern is repeated periodically. In other words, the code pattern is arranged on a circle of length 384. Each window W of a length w=9 forms a code word with minimum distance d=1 which means that each code word differs from all other code words in at least one bit. This code pattern allows to get into lock and stay in lock by using a delay line with 9 taps and a 9-bit-to-9-bit table that decodes the position from the code words.

The code pattern further has the following additional properties that allow different implementations of the synchronization mechanism:

1. If the length of the window W is extended to w=15 then a minimum distance d=3 is reached. This additional redundancy can be used to decrease the probability of misdetection, i. e. the output of a wrong position, or, alternatively, it can be used to correct a one-bit error.

2. There is a position of the window W of length w=12 corresponding to a code word such that it has minimum distance d≧3 to all other code words corresponding to the other positions of the window W of length w=12 in the code pattern. This window is called a marker M and has a fixed position within the code pattern C. This marker M allows reliable detection of a fixed reference position with a very simple implementation that only compares the last 12 input bits with the fixed bit vector and outputs a signal if there is a match.

3. The code pattern can be generated with a linear feedback shift register (LFSR) of length 9 which simplifies the generation of the code pattern in any implementation.

These properties are described with reference to the above example of a code pattern comprising 384 bits, but are valid for code patterns in general used according to the invention having a different number of bits and where the lengths w of said code words (or windows W) are different.

The properties of the code pattern allow for different implementations of getting in lock and remaining in lock while reading double superframes. The implementor can make the choice between a very cheep solution that detects a single marker, a decoder that outputs the position of any F3-frame in a more expensive decoder or that outputs the position even in the presence of single-bit errors.

In general if the code pattern consists of n bits where n is specified by the application then only the first log₂(n) bits (in the example holds n=384, so log₂(n)=9 need to be read to get into lock after the receiver is switched on. The next bits can then be predicted by a LFSR which makes it much easier for the receiver to keep track of the position in the code pattern, i. e. it is much easier to stay in lock.

The generation of a code pattern of a fixed length of n bits shall now be explained in more detail. For smaller numbers of n, for example up to n=48, all bit strings of length n can be enumerated and its performances can be measured using a computer program. Finally the bit string having the best performances can be selected and used as code pattern.

The main important performance measures are:

a) Minimum length of a window which is required such that two different windows of the code pattern differ in at least d bits.

b) Minimum length of a window which is required such that there is at least one window which differs in at least d bits from any other window.

For larger numbers of n the parameter m is selected such that N=2^{m}−1≧n. Then all shift registers having m taps and full length are enumerated using a computer program. These are the linear feedback shift registers. For each such LFSR the corresponding bitstream of N bits is formed. For all partial bitstreams having a length n of the bitstreams having a length N determined above are then considered, and the performances of these partial bitstreams are measured. The partial bitstream having the best performances for the respective application is then selected as code pattern.

An example for such a linear feedback shift register for selecting a code pattern is shown in FIG. 6. This LFSR has full length 7=2³−1. The following bitstreams are generating in the respective taps:

| X2 | X1 | X0 |
|---|---|---|
| 1 | 0 | 0 |
| 1 | 1 | 0 |
| 1 | 1 | 1 |
| 0 | 1 | 1 |
| 1 | 0 | 1 |
| 0 | 1 | 0 |
| 0 | 0 | 1 |
| 1 | 0 | 0 |

The periodical bitstream which will then be used as code pattern results in [0011101].

An implementation which can be used according to the invention for locating a marker in the code pattern with error correction is shown in FIG. 7. Therein m=[m(k), . . . , m(0)] is the code word corresponding to the marker. After it has been logged into the code pattern, without knowing the exact position, the code pattern bits I0, I1, I2, I3, etc. are read. These serve as inputs in the shift register represented by the delay elements D. The shift register has some code word d=[d(k), . . . , d(0)] in its memory. The XOR-gates 30 are used to XOR words mand d. The number of non-zero entries of the resulting vector e=[e(k), . . . , e(0)] is computed by means 31. If this number is less than or equal to t, the maximum number of errors which should be correctable, then it outputs L=1 and otherwise it outputs L=0. The value L=1 indicates that the code word d is at most at a distance t of the code word m corresponding to the marker. In this case the marker has been located if the distance of the marker to any of the other code words is at least 2t+1.

An implementation which can be used according to the invention for decoding a position in the code pattern without error correction is shown in FIG. 8. Initially, the code word (without bit errors) corresponding to the position which should be determined is fed into the shift register represented by the delay elements D. Every clock cycle the shift register is updated by means of a feed-back loop. The shift register together with this feed-back loop is shown in box 32. This box 32 represents the linear feed-back shift register used to generate the code pattern. The content of the shift register serves as input of means 33, which are also shown in FIG. 7 in which t=0 and m is taken as the last code word in the code pattern. The output of means 33 equals L=1 if the code word in the shift register matches m and it equals L=0 otherwise. By using the integer sum 34 it is counted by C how many clock cycles are needed until the last code word of the code pattern is computed. So, this number C represents the position of the initial code word. In case it is required to be able to find a position if the initial code word does suffer from bit errors then a look-up table needs to be used.

It shall be mentioned that the scope is not limited to the embodiments shown and explained above. In contrast, further embodiments and variations are possible. According to the invention synchronization and/or position detection at any position in the bitstream is reliably possible, even in the presence of bit errors.

1. Method for generating a serial bitstream comprising information for synchronizing the serial bitstream internally and/or to another serial bitstream and/or for determining the position in the serial bitstream wherein a fixed code pattern is embedded in the serial bitstream, characterized in that the code pattern is periodically repeated in the serial bitstream and that any sequence of a fixed number of successive bits of the code pattern forms a unique code word allowing for synchronization and/or position determination.

2. Method according to claim 1, characterized in that the code pattern and the number of successive bits forming a code word are selected such that at least a one-bit error in any code word is correctable.

3. Method as claimed in claim 1, characterized in that the code pattern and the number of successive bits forming a code word are selected such that at least one marker at a fixed position in the bitstream is created allowing for a detection of a reference position in the bitstream even if a one-bit error occurs in the marker.

4. Method as claimed in claim 1, characterized in that the code words are generated and/or detected by a linear feedback shift register.

5. Method as claimed in claim 1, characterized in that the code pattern is embedded in a channel bitstream of user data stored on a record carrier or transmitted over a transmission line.

6. Method as claimed in claim 1, characterized in that the serial bitstream is separated into superframes consisting of a fixed number of frames and that the code pattern is completely embedded in one superframe.

7. Method as claimed in claim 6, characterized in that one bit of the code pattern is embedded in each frame of said superframe.

8. Device for generating a serial bitstream comprising information for synchronizing the serial bitstream internally and/or to another serial bitstream and/or for determining the position in the serial bitstream comprising code generating means for generating a fixed code pattern and coding means for embedding said fixed code pattern in the serial bitstream, characterized in that the coding means are provided for embedding the code pattern in the serial bitstream such that the code pattern is periodically repeated and that the code generating means are provided for generating the code pattern such that any sequence of a fixed number of successive bits of the code pattern forms a unique code word allowing for synchronization and/or position determination.

9. Binary signal comprising a serial bitstream and information for synchronizing the serial bitstream internally and/or to another serial bitstream and/or for determining the position in the serial bitstream wherein said information includes a fixed code pattern embedded in the serial bitstream, characterized in that the code pattern is periodically repeated in the serial bitstream and that any sequence of a fixed number of successive bits of the code pattern forms a unique code word allowing for synchronization and/or position determination.

10. Record carrier carrying a binary signal according to claim 9.

11. Record carrier according to claim 10, wherein the record carrier is an optical record carrier, in particular a CD or a DVD.

12. Method for reading a binary signal according to claim 9 using the code pattern embedded in the serial bitstream to synchronize the serial bitstream internally and/or to another serial bitstream containing the identical code pattern and/or to determine the position in the serial bitstream.

13. Method according to claim 12, characterized in that the position in the serial bitstream is determined by converting the code word into a position information using a look-up table or a conversion algorithm.

14. Device for reading a binary signal according to claim 9 comprising means for using the code pattern to synchronize the serial bitstream internally and/or to another serial bitstream containing the identical code pattern and/or to determine the position in the serial bitstream.
